(19) United States
(12) Patent Application Publication
(10) Pub. No.: US 2023/0323780 A1
(43) Pub. Date: Oct. 12, 2023

(54) STEAM TURBINE

(71) Applicant: MITSUBISHI HEAVY INDUSTRIES, LTD., Tokyo (JP)

(72) Inventors: Ryo Takata, Tokyo (JP); Soichiro Tabata, Yokohama-shi (JP); Yasuhiro Sasao, Yokohama-shi (JP)

(73) Assignee: MITSUBISHI HEAVY INDUSTRIES, LTD., Tokyo (JP)

(21) Appl. No.: 18/025,011

(22) PCT Filed: Sep. 28, 2020
(86) PCT No.: PCT/JP2020/036543

§ 371 Date: Mar. 7, 2023

(51) Int. Cl. F01D 9/04

(52) U.S. Cl. CPC F01D 9/041; F05D 2220/31

(57) ABSTRACT

A steam turbine including a rotor shaft, a plurality of moving blade rows, a casing, and fixed blade rows disposed on a first side in the axial direction, relative to each of the plurality of moving blade rows. The last fixed blade row, disposed furthest on a second side in the axial direction among the plurality of moving blade rows, includes a plurality of fixed blades disposed at intervals in the circumferential direction and each extending in the radial direction; an outside ring having an annular shape and being disposed on the outside, in the radial direction, of the plurality of fixed blades; and an inside ring having an annular shape and being disposed on the inside, in the radial direction, of the plurality of fixed blades.

### TECHNICAL FIELD

The present disclosure relates to a steam turbine.

### BACKGROUND ART

A steam turbine has a plurality of rows of compression stages in a casing. Steam flowing from an upstream side to a downstream side through the plurality of rows of compression stages in the casing expands as the steam flows toward the downstream side, which causes a decrease in pressure and temperature thereof. Particularly, in some cases, the humidity of the steam increases in the vicinity of a last compression stage row, which causes moisture in the steam to become liquid droplets. An increase in humidity of the steam results in a decrease in efficiency of the steam turbine. In addition, in a case where the moisture in the steam becomes liquid droplets, so-called erosion, an which the liquid droplets scattered from a stator vane corrode a last rotor blade row, may be caused.

With regard to this, for example, disclosed in PTL 1 is a steam turbine having a configuration in which an axial interval between a stator vane and a rotor blade on an outer side in a radial direction is larger than that on an inner side in the radial direction. According to such a configuration, the axial interval between the stator vane and the rotor blade is made large on the outer side in the radial direction, so that there is an increase in amount of liquid droplets that adhere to an outer peripheral wall downstream of the stator vane because of the effect of a centrifugal force caused by a swirling stream flowing out from the stator vane. Accordingly, the liquid droplets are restrained from reaching a tip of the rotor blade on a downstream side so that erosion is made less likely to occur.

### CITATION LIST

### Patent Literature

[PTL 1] Japanese Patent No. 3815143

### SUMMARY OF INVENTION

### Technical Problem

However, in the case of a configuration as disclosed in PTL 1, increasing the axial interval between the stator vane and the rotor blade results in a decrease in turbine performance. In addition, increasing the axial interval between the stator vane and the rotor blade results in an increase in size of an axial interval between compression stages. Therefore, there are an increase in axial length of a rotary shaft and an increase in bearing span, which results in a decrease in shaft vibration reliability.

The present disclosure has been made to solve the above-described problems, and an object thereof is to provide a steam turbine with which it is possible to more effectively suppress occurrence of erosion while suppressing a decrease in turbine performance and a decrease in shaft vibration reliability.

### Solution to Problem

According to an aspect of the present disclosure for solving the above-described problem, there is provided a steam turbine including: a rotor shaft that rotates around an axis; a plurality of rotor blade rows that are disposed at intervals in an axial direction along the axis, the rotor blade rows being fixed to a portion of the rotor shaft that is on an outer side in a radial direction; a casing that is disposed to cover the rotor shaft and the plurality of rotor blade rows; and stator vane rows that are disposed at intervals in the axial direction and that are disposed on a first side in the axial direction with respect to the plurality of rotor blade rows, respectively, the stator vane rows being fixed to a portion of the casing that is on an inner side in the radial direction. The stator vane row includes a plurality of stator vanes that are disposed at intervals in a circumferential direction and each of which extends in the radial direction, an outer ring that has an annular shape and that is disposed closer to the outer side in the radial direction than the plurality of stator vanes are, and an inner ring that has an annular shape and that is disposed closer to an inner side in the radial direction than the plurality of stator vanes are, and at a last stator vane row that is disposed to be closest to a second side in the axial direction among the plurality of stator vane rows, a second-side edge portion of the stator vane that is on the second side in the axial direction has an S-like shape including a second-side convex portion that is formed on the inner side in the radial direction with respect to an intermediate position between an outer end of the stator vane on the outer side in the radial direction and an inner end of the stator vane on the inner side in the radial direction and that protrudes while being curved toward the second side in the axial direction, and a second-side concave portion that is formed on the outer side in the radial direction with respect to the intermediate position and that is recessed while being curved toward the first side in the axial direction.

### Advantageous Effects of Invention

According to the steam turbine of the present disclosure, it is possible to effectively suppress the occurrence of erosion while suppressing a decrease in turbine performance and a decrease in shaft vibration reliability.

### BRIEF DESCRIPTION OF DRAWINGS

FIG. 1 is a schematic view showing a schematic configuration of a steam turbine according to an embodiment of the present disclosure.

FIG. 2 is a cross-sectional view showing a last stator vane row and a last rotor blade row of the steam turbine in a first embodiment of the present disclosure.

FIG. 3 is a perspective view showing a portion of the last stator vane row in the first embodiment of the present disclosure.

FIG. 4 is a view illustrating the cross-sectional shape of a stator vane that constitutes the last stator vane row in the first embodiment of the present disclosure.

FIG. 5 is a cross-sectional view showing a last stator vane row and a last rotor blade row of a steam turbine in a second embodiment and a third embodiment of the present disclosure.

FIG. 6 is a view illustrating the cross-sectional shape of a stator vane in the second embodiment of the present disclosure.

FIG. 7 is a view illustrating the cross-sectional shape of a stator vane in the third embodiment of the present disclosure.

### DESCRIPTION OF EMBODIMENTS

### First Embodiment

(Configuration of Steam Turbine)

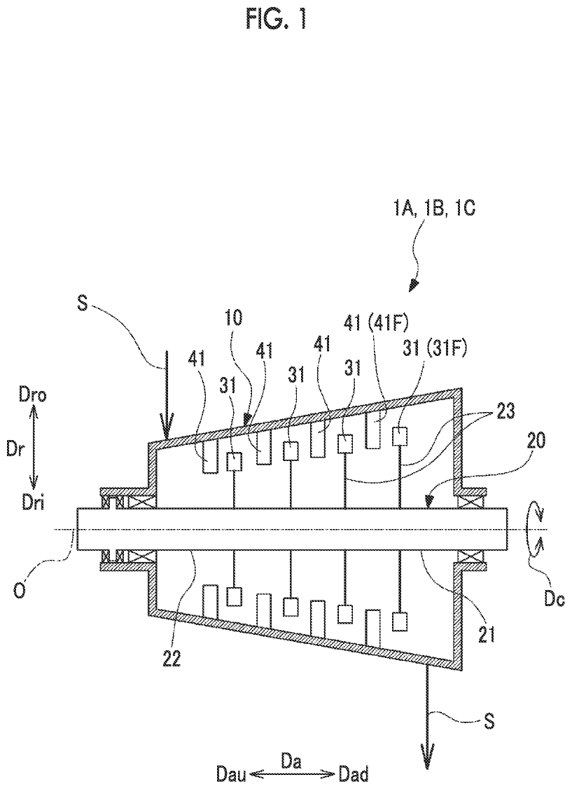

As shown in FIG. 1, a steam turbine 1A of the present embodiment includes a rotor 20 that rotates around an axis O and a casing 10.

Note that, in the following description, for the sake of convenience, a direction in which the axis O extends will be simply referred to as an axial direction Da, a radial direction of a shaft core portion 22 (which will be described later) based on the axis O will be simply referred to as a radial direction Dr, and a circumferential direction of the shaft core portion 22 that extends around the axis O will be simply referred to as a circumferential direction Dc.

(Configuration of Rotor)

The rotor 20 includes a rotor shaft 21 and rotor blade rows 31.

The rotor shaft 21 is disposed to be rotatable around the axis O. The rotor shaft 21 includes the shaft core portion 22 and a plurality of disc portions 23. The shaft core portion 22 has a columnar shape around the axis O and extends in the axial direction Da. The plurality of disc portions 23 are disposed at intervals in the axial direction Da. Each of the disc portions 23 is disposed to extend from the shaft core portion 22 to an outer side Dro in the radial direction Dr.

(Configuration of Rotor Blade Row)

The rotor blade rows 31 are fixed to a portion of the rotor shaft 21 that is on the outer side Dro in the radial direction Dr. The rotor blade rows 32 are attached to outer peripheries of the disc portions 23 which are outer peripheral portions of the rotor shaft 21. A plurality of the rotor blade rows 31 are disposed at intervals along the axial direction Da of the rotor shaft 21. In the case of the present embodiment, four rotor blade rows 31 are disposed, for example. Therefore, in the case of the present embodiment, as the rotor blade rows 31, first to fourth stages of the rotor blade rows 31 are disposed.

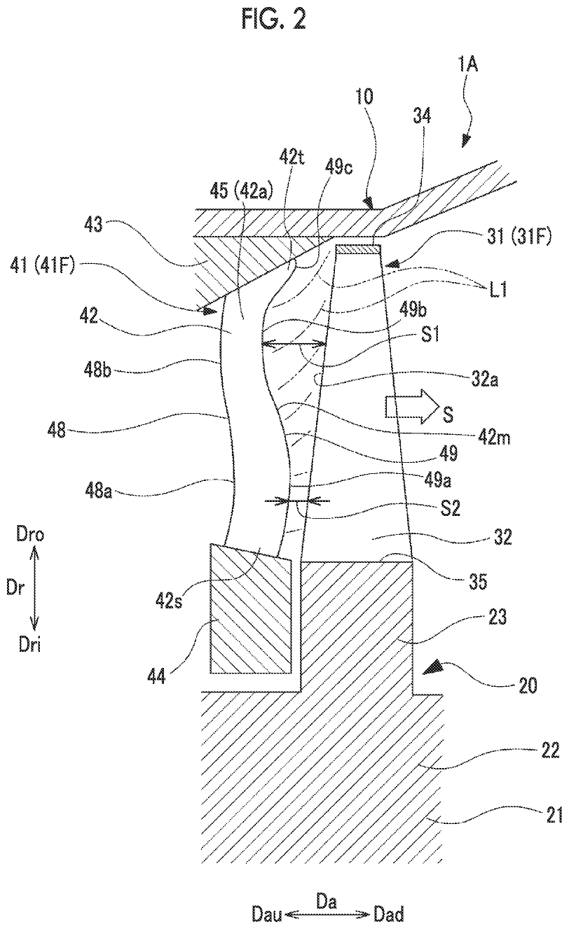

As shown in FIG. 2, each of the rotor blade rows 31 includes a plurality of rotor blades 32 arranged in the circumferential direction Dc, a shroud 34, and a platform 35. Each of the rotor blades 32 extends in the radial direction Dr. The shroud 34 is disposed closer to the outer side Dro in the radial direction Dr than the rotor blades 32 are. The platform 35 is disposed closer to an inner side Dri in the radial direction Dr than the rotor blades 32 are. Steam S flows through an annular space between the shroud 34 and the platform 35 at the rotor blades 32.

(Configuration of Casing)

As shown in FIG. 1, the casing 10 is formed to cover the rotor 20. Stator vane rows 41 are fixed to a portion of the casing 10 that is on the inner side Dri in the radial direction Dr. A plurality of the stator vane rows 41 are disposed at intervals along the axial direction Da. In the present embodiment, the number of stator vane rows 41 is four, which is equal to the number of the rotor blade rows 31. The stator vane rows 41 are disposed to be adjacent to the plurality of rotor blade rows 31 while being on a first side Dau in the axial direction Da, respectively. The first side Dau in the axial direction Da is an upstream side in a direction in which the steam S flows in the casing 10. That is, the steam S flows from the first side Dau to a second side Dad in the axial direction Da inside the casing 10.

(Configuration of Stator Vane Row)

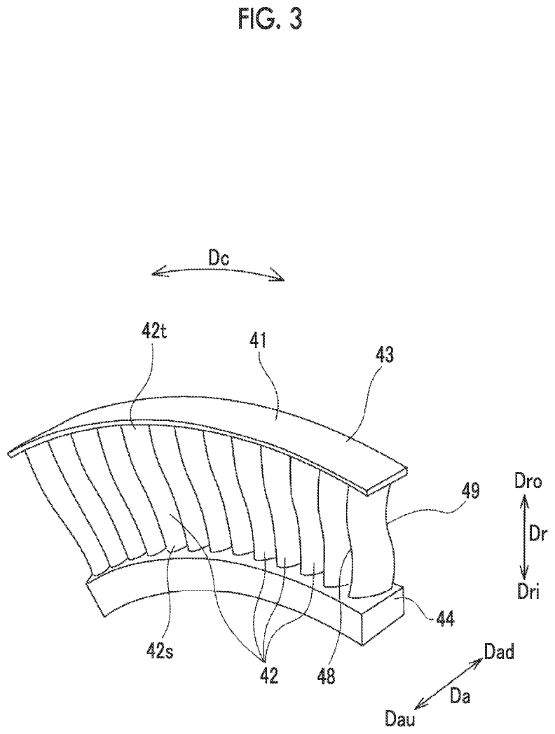

As shown in FIGS. 2 and 3, each of the stator vane rows 41 includes stator vanes 42, an outer ring 43, and an inner ring 44. A plurality of the stator vanes 42 are disposed at intervals in the circumferential direction Dc. The outer ring 43 has an annular shape and is disposed closer to the outer side Dro in the radial direction Dr than the plurality of stator vanes 42 are. The inner ring 44 has an annular shape and is disposed closer to the inner side Dri in the radial direction Dr than the plurality of stator vanes 42 are. The steam S flows in an annular space between the outer ring 43 and the inner ring 44.

An inner end 42s of each of the stator vanes 42, which is on the inner side Dri in the radial direction Dr, is fixed to the inner ring 44. An outer end 42t of each of the stator vanes 42, which is on the oater side Dro in the radial direction Dr, is fixed to the outer ring 43.

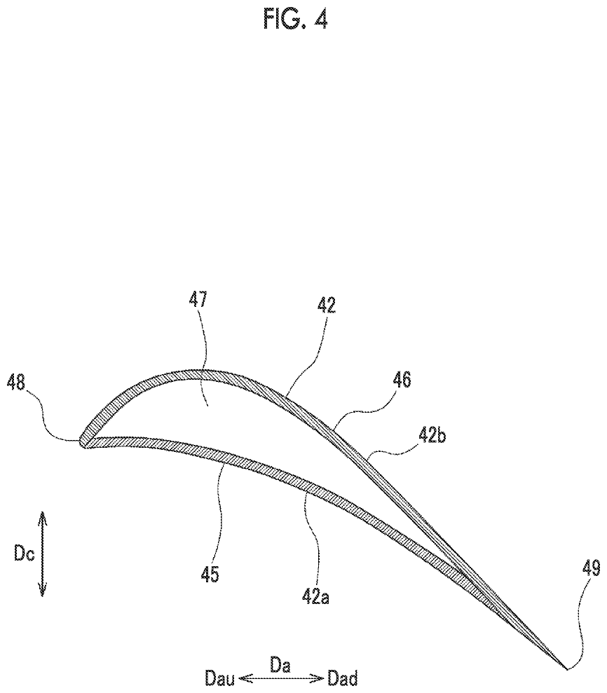

As shown in FIG. 4, the stator vane 42 has a vane cross-sectional shape in a cross-sectional view as seen in the radial direction Dr (a direction orthogonal to the paper surface of FIG. 4) over an area from a first-side edge portion 48 to a second-side edge portion 49, the first-side edge portion 48 being on the first side Dau in the axial direction Da and the second-side edge portion 49 being on the second side Dad in the axial direction Da. The stator vane 42 is formed by a pressure-side member 45 and a suction-side member 46. The pressure-side member 45 is formed to be curved in a concave shape such that a surface thereof forms a pressure surface 42a of the stator vane 42. The suction-side member 46 is formed to be curved in a convex shape such that a surface thereof forms a suction surface 42b of the stator vane 42. Each of the pressure-side member 45 and the suction-side member 46 is obtained by bending a metal plate-like component into a predetermined shape. The stator vane 42 is formed by combining the pressure-side member 45 and the suction-side member 46 with each other and welding the pressure-side member 45 and the suction-side member 46. Accordingly, a cavity portion 47 is formed inside the stator vane 42, that is, between the pressure-side member 45 and the suction-side member 46.

As shown in FIG. 2, the second-side edge portion 49 of the stator vane 42 includes a second-side convex portion 49a, a second-side concave portion 49b, and a vane end extending portion 49c.

The second-side convex portion 49a is formed on the inner side Dri in the radial direction Dr with respect to an intermediate position 42m between the outer end 42t and the inner end 42s of the stator vane 42. The second-side convex portion 49a is formed to be curved in a convex shape such that the second-side convex portion 49a protrudes toward the second side Dad in the axial direction Da. More specifically, the second-side convex portion 49a is formed to be curved such that the second-side convex portion 49a protrudes to be closer to the second side Dad in the axial direction Da than the inner end 42s and the intermediate position 42m are.

For example, the intermediate position 42m may be the center of a space between both ends of the second-side edge portion 49 of the stator vane 42 in the radial direction Dr.

The second-side concave portion 49b is continuously formed on the outer side Dro in the radial direction Dr with respect to the intermediate position 42m. The second-side concave portion 49b is formed to be recessed and curved toward the first side Dau in the axial direction Da. The second-side concave portion 496 is formed to be curved in a concave shape such that the second-side concave portion 49b is recessed to be closer to the first side Dau in the axial direction Da than the intermediate position 42m and the outer end 42t are.

The vane end extending portion 49c is continuously formed on the outer side Dro in the radial direction Dr with respect to the second-side concave portion 49b. The vane end extending portion 49h extends to protrude from the second-side concave portion 49b to the second side Dad in the axial direction Da and is connected to the outer ring 43.

Accordingly, the second-side edge portion 49 has an S-like shape as seen in the circumferential direction Dc.

For example, the second-side edge portion 49 may have an S-like shape over an area from the outer end 42t to the inner end 42s of the stator vane 42.

For example, the first-side edge portion 48 of the stator vane 42 may include a first-side concave portion 48a and a first-side convex portion 48b and may be formed in an S-like shape.

For example, the first-side edge portion 48 may have an S-like shape over an area from the outer end 42t to the inner end 42s of the stator vane 42.

The first-side concave portion 43a is formed at a portion of the stator vane 42 that is on the inner side Dri in the radial direction Dr. The first-side concave portion 48a is formed to be curved in a concave shape such that the first-side concave portion 41a is recessed toward the second side Dad in the axial direction Da.

The first-side convex portion 48b is continuously formed on the outer side Dro in the radial direction Dr with respect to the first-side concave portion 48a. The first-side convex portion 48b is formed to be curved in a convex shape such that the first-side convex portion 43b protrudes toward the first side Dau in the axial direction Da.

(Operation and Effect)

According to the steam turbine 1A as described above, the second-side concave portion 49b of the second-side edge portion 49 of the stator vane 42 is recessed toward the first side Dau in the axial direction Da. Therefore, an interval S1 between the second-side concave portion 49b and the rotor blade 32 of a last rotor blade row 31F is made large in the axial direction Da. Accordingly, because of the effect of a centrifugal, force caused by a swirling stream flowing out from the stator vane 42, liquid droplets flow from the stator vane 42 to the second side Dad in the axial direction Da and flow to the outer side Dro in the radial direction Dr via a steam stream represented by virtual lines L1 in FIG. 2. Therefore, the amount of liquid droplets reaching an end portion 32a of the rotor blade 32 that is on the first side Dau in the axial direction Da can be suppressed. As a result, erosion cart be made less likely to occur.

In addition, the second-side convex portion 49a of the second-side edge portion 49 of the stator vane 42 protrudes toward the second side Dad in the axial direction Da. Therefore, an interval S2 between the second-side convex portion 49a and the last rotor blade row 31F can be made small in comparison with the interval S1 at the second-side concave portion 49b. As a result, a decrease in turbine performance can be suppressed. In addition, since the interval S2 between the second-side convex portion 49a and the rotor blade 32 of the last rotor blade row 31F is made small, an increase in bearing span can be suppressed, and a decrease in shaft vibration reliability can be suppressed. In addition, since the second-side convex portion 49a is formed on the inner side Dri in the radial direction Dr, the circumferential speed of a stream of the steam S is small in comparison with that on the outer side Dro in the radial direction Dr, and thus, erosion is less likely to occur. As a result, it is possible to effectively suppress the occurrence of erosion while suppressing a decrease in turbine performance and a decrease in shaft vibration reliability.

The steam turbine 1A as described above further includes the vane end extending portion 49c that is continuously formed on the outer side Dro in the radial direction Dr with respect to the second-side concave portion 49b and that extends toward the second side Dad in the axial direction Da.

Accordingly, because of the effect of a centrifugal force caused by a swirling stream flowing out from the stator vane 42, liquid droplets flowing toward the outer side Dro in the radial direction Dr can be restrained from being accumulated at the second-side concave portion 49b. Therefore, the liquid droplets are smoothly guided from the vane end extending portion 49c to the outer ring 43. Since the liquid droplets are guided to the outer ring 43 in such a manner, the amount of liquid droplets reaching the end portion 32a of the rotor blade 32 on the first side Dau in the axial direction Da can be suppressed more effectively.

According to the steam turbine 1A as described above, the first-side edge portion 48 includes the first-side concave portion 48a and the first-side convex portion 48b and has an S-like shape.

Accordingly, the vane surface length of the stator vane 42 at a time when the first-side edge portion 48 and the second-side edge portion 49 are connected in the axial direction Da is restrained from being locally large in comparison with a case where the first-side edge portion in of the stator vane 42 is formed in a linear shape extending along the radial direction Dr. Specifically, the length of a flow path from the first-side concave portion 48a to the second-side convex portion 49a and the length of a flow path from the first-side convex portion 48b to the second-side concave portion 49b along the axial direction Da can be restrained from being significantly different from each other. Accordingly, a friction loss generated between the liquid droplets and a surface of the stator vane 42 can be restrained from being significantly different in parts in the radial direction Dr.

### Second Embodiment

Next, a second embodiment of the steam turbine according to the present disclosure will be described. The steam turbine in the second embodiment is different from the steam turbine of the first embodiment only in that a slit is provided. Therefore, in the description of the second embodiment, the same parts as those of the first embodiment will be described with the same reference numerals, and repetitive description will be omitted. That is, the description about the configuration of each part of the steam turbine which has the same configuration as that in the first embodiment will be omitted.

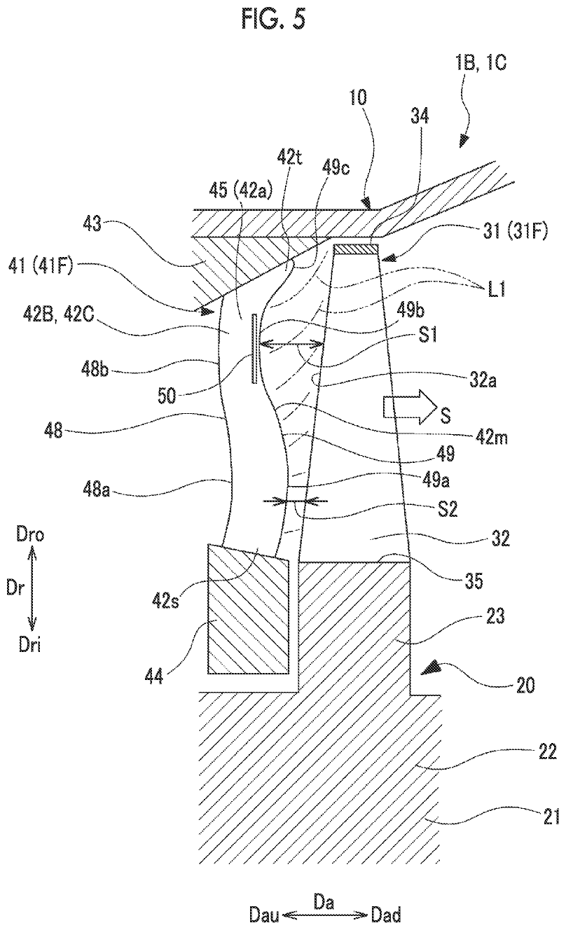

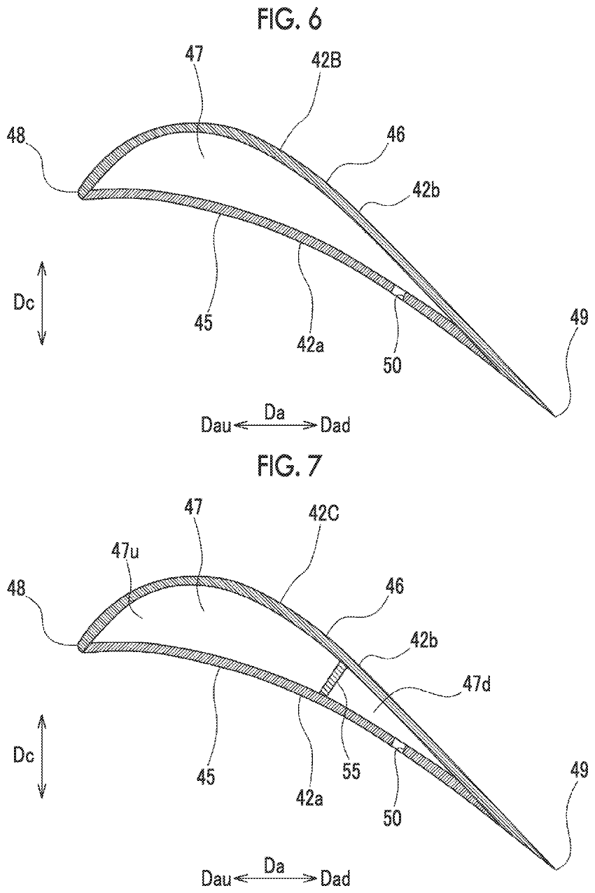

As shown in FIGS. 5 and 6, a stator vane 42B constituting the stator vane row 41 of a steam turbine 1B of the present embodiment includes a communication hole 50.

In the radial direction Dr, the communication hole 50 is formed at a position closer to the outer side Dro in the radial direction Dr than the intermediate position 42m is.

The communication hole 50 is formed such that an outer surface of the pressure-side member 45 of the stator vane 42B and the cavity portion 47 communicate with each other.

For example, the communication hole 50 may be a slit that continuously extends in the radial direction Dr.

For example, the communication hole 50 may be, instead of a slit, one or more holes through which the outer surface of the pressure-side member 45 of the stator vane 42B and the cavity portion 47 communicate with each other.

For example, in the radial direction Dr, the communication hole 50 may be formed only at a position closer to the outer side Dro in the radial direction Dr than the intermediate position 42m is, the position being on the outer surface of the pressure-side member 45 of the stator vane 42B.

For example, the communication hole 50 may be formed only at a position closer to the second-side edge portion 49 than the first-side edge portion 48 is, the position being on the outer surface of the pressure-side member 45 of the stator vans 42B.

In the case of such a configuration, a portion of liquid droplets generated in steam flowing through the stator vane row 41 is recovered at the cavity portion 47 in the stator vane 42B through the communication hole 50. The recovered liquid droplets in the cavity portion 47 are discharged to the outside of the casing 10 via a liquid droplet recovery groove (not shown) or the like formed at the outer ring 43 or the inner ring 44.

(Operation and Effect)

According to the steam turbine 1B as described above, as with the first embodiment, it is possible to effectively suppress the occurrence of erosion while suppressing a decrease in turbine performance and a decrease in shaft vibration reliability.

In addition, in the steam turbine 1B, at least a portion of liquid droplets can be recovered at the cavity portion 47 in the stator vane 42B through the communication hole 50. Accordingly, the amount of liquid droplets reaching the end portion 32a of the rotor blade 32 that is on the first side Dau in the axial direction Da can be suppressed more effectively. Therefore, it is possible to more significantly achieve an effect in which it is possible to effectively suppress the occurrence of erosion while suppressing a decrease in turbine performance and a decrease in shaft vibration reliability.

In addition, in the steam turbine 1B, the communication hole 50 is formed closer to the outer side Dre in the radial direction Dr than the intermediate position 42m is. Therefore, the processing area of the communication hole 50 can be reduced.

In addition, in the steam turbine 1B, the communication hole 50 is formed closer to the outer side Dro in the radial direction Dr than the intermediate position 42m is. Therefore, the cavity portion 41 of the stator vane 42B can be made small in relation to the position of the communication hole 50. Therefore, liquid droplets in the cavity portion 47 are easily discharged.

In addition, in the steam turbine 1B, the communication hole 50 is formed only at a position closer to the second-side edge portion 49 than the first-side edge portion 48 is, the position being on the outer surface of the pressure-side member 45 of the stator vane 42B. Therefore, the second-side edge portion 49 of the stator vane 42B can have a heat blocking structure.

### Third Embodiment

Next, a third embodiment of the steam turbine according to the present disclosure will be described. The steam turbine in the third embodiment is different from the steam turbine of the second embodiment only in that a partition wall is provided inside a stator vane. Therefore, in the description of the third embodiment, the same parts as those of the second embodiment will be described with the same reference numerals, and repetitive description will be omitted. That is, the description will be made focusing on differences between the second embodiment and the third embodiment, and the description about the same configuration as that in the first embodiment and the second embodiment will be omitted.

As shown in FIGS. 5 and 7, a stator vane 42C constituting the stator vane row 41 of a steam turbine 1C of the present embodiment includes the communication hole 50 and a partition wall 55 (refer to FIG. 7).

In the radial direction Dr, the communication hole 50 is formed at a position closer to the outer side Dro in the radial direction Dr than the intermediate position 42m is. As shown in FIG. 7, the communication hole 50 is formed such that the outer surface of the pressure-side member 45 of the stator vane 42C and the cavity portion 47 communicate with each other.

The partition wall 55 is formed inside the stator vane 42C. The partition wall 55 is bonded to the pressure-side member 45 and to the suction-side member 46 at a position between the first-side edge portion 48 and the second-side edge portion 49. The partition wall 55 is disposed closer to the first side Dau in the axial direction Da than the communication hole 50 is. The partition wall 5 continuously extends in the radial direction Dr. The partition wall 55 partitions the cavity portion 47 inside the stator vane 42C into a first cavity portion 47u on the first side Dau in the axial direction Da and a second cavity portion 47d on the second side Dad.

For example, the stator vane 42 may be an assembly having a split structure composed of a component including a communication hole 50 and a component including no communication hole 50 with the partition wall 55 serving as a boundary.

In the case of such a configuration, a portion of liquid droplets generated in steam flowing through the stator vane row 41 is recovered at the second cavity portion 47d in the stator vane 42C through the communication hole 50, the second cavity portion 47d being closer to the second side Dad in the axial direction Da than the partition wall 55 is. The recovered liquid droplets in the second cavity portion 47d are discharged to the outside of the casing 10 via a liquid droplet recovery groove (not shown) or the like formed at the outer ring 43 or the inner ring 44. The partition wall 55 restrains the liquid droplets in the second cavity portion 47d from entering the first cavity portion 47u that is closer to the first side Dau in the axial direction Da in the cavity portion 47 than the partition wall 55 is.

(Operation and Effect)

According to the steam turbine 1C an described above, as with the first embodiment and the second embodiment, it is possible to effectively suppress the occurrence of erosion while suppressing a decrease in turbine performance and a decrease in shaft vibration reliability.

In addition, in the case of the steam turbine 1C, since the partition wall 55 is provided, it is possible to reduce a flow path cross-sectional area at a portion (the second cavity portion 47d) that is on the second side Dad in the axial direction Da with respect to the partition wall 55 of the cavity portion 47 in the stator vane 42C and at which liquid droplets are recovered. In addition, it is possible to restrain liquid droplets recovered into the second cavity portion 47d in the stator vane 42C from moving to the first cavity portion 47u in the stator vane 42C. Therefore, it is possible to configure a portion of the stator vane 42C that is close to the first-side edge portion 48 on the first side Dau in the axial direction Da to have a sealed heat blocking structure.

Furthermore, according to the steam turbine 1C, it is possible to provide the stator vane 42 that is easy to manufacture because the stator vane 42 is an assembly having a split structure with the partition wall 55 serving as a boundary.

### Other Embodiments

Note that the present disclosure is not limited to the above-described embodiments, and the design can be changed without departing from the gist of the present disclosure.

For example, in the above-described embodiments, the second-side convex portion 49a and the second-side concave portion 49b of the second-side edge portion 49 are formed to be curved. However, the specific shapes thereof are not limited. For example, the second-side convex portion 49a and the second-side concave portion 49b may be curved with a constant curvature, and the curvatures of the second-side convex portion 49a and the second-side concave portion 49b may be partially different from each other.

In addition, although the first-side edge portion 48 has an S-like shape as with the second-side edge portion 49, the present disclosure is not limited thereto. The first-side edge portion 48 may be linear, for example.

In addition, for example, in addition to the number of stages of the rotor blade rows 31 and the stator vane rows 41, the configuration of each part of the steam turbines A, 1B, and 1C can be appropriately changed.

### APPENDIX

The steam turbines 1A, 1B, and 1C described in the embodiments are understood as follows, for example.

(1) The steam turbines 1A, 1B, and 1C according to a first aspect include: the rotor shaft 21 that rotates around the axis O; the plurality of rotor blade rows 31 that are disposed at intervals in the axial direction Da along the axis O, the rotor blade rows 31 being fixed to a portion of the rotor shaft 21 that is on the outer side Dro in the radial direction Dr; the casing 10 that is disposed to cover the rotor shaft 21 and the plurality of rotor blade rows 31; and the stator vane rows 41 that are disposed at intervals in the axial direction Da and that are disposed on the first side Dau in the axial direction Da with respect to the plurality of rotor blade rows 31, respectively, the stator vane rows 41 being fixed to a portion of the casing 10 that is on the inner side Dri in the radial direction Dr. The stator vane row 41 includes the plurality of stator vanes 42, 42B, and 42C that are disposed at intervals in the circumferential direction Do and each of which extends in the radial direction Dr, the outer rings 43 that have an annular shape and that are disposed closer to the outer side Dro in the radial direction Dr than the plurality of stator vanes 42, 42B, and 42C are, and the inner ring 44 that has an annular shape and that is disposed closer to the inner side Dri in the radial direction Dr than the plurality of stator vanes 42, 42B, and 42C are, and at a last stator vane row 41F that is disposed to be closest to the second side Dad in the axial direction Da among the plurality of stator vane rows 41, the second-side edge portion 49 of the stator vanes 42, 42B, and 42C that is on the second side Dad in the axial direction Da has an S-like shape including the second-side convex portion 49a that is formed on the inner side Dri in the radial direction Dr with respect to the intermediate position 42m between the outer end 42t of the stator vanes 42, 42B, and 42C on the outer side Dro in the radial direction Dr and the inner end 42s of the stator vanes 42, 42b, and 42C on the inner side Dri in the radial direction Dr and that protrudes while being curved toward the second side Dad in the axial direction Da, and the second-side concave portion 495 that is formed on the outer side Dro in the radial direction Dr with respect to the intermediate position 42m and that is recessed while being curved toward the first side Dau in the axial direction Da.

According to the steam turbines 1A, 1B, and 1C as described above, the second-side concave portion 49b of the second-side edge portion 49 of the stator vanes 42, 42B, and 42C is recessed toward the first side Dau in the axial direction Da. Therefore, the interval S1 between the second-side concave portion 49b and the rotor blade 32 of a last rotor blade row 31F is made large in the axial direction Da. Accordingly, because of the effect of a centrifugal force caused by a swirling stream flowing out from the stator vanes 42, 42B, and 42C, liquid droplets flow from the stator vanes 42, 42B, and 42C to the second side Dad in the axial direction Da and flow to the outer side Dro in the radial direction Dr via a steam stream. Therefore, the amount of liquid droplets reaching the end portion 32a of the rotor blade 32 that is on the first side Dau in the axial direction Da can be suppressed. As a result, erosion can be made less likely to occur.

In addition, the second-side convex portion 49a of the second-side edge portion 49 of the stator vanes 42, 42B, and 42C protrudes toward the second side Dad in the axial direction Da. Therefore, the interval S2 between the second-side convex portion 49a and the rotor blades 32 of the last row can be made small in comparison with the interval S1 at the second-side concave portion 49b. As a result, a decrease in turbine performance can be suppressed. In addition, an increase in bearing span can be suppressed, and a decrease in shaft vibration reliability can be suppressed. As a result, it is possible to effectively suppress the occurrence of erosion while suppressing a decrease in turbine performance and a decrease in shaft vibration reliability.

(2) The steam turbines 1A, 1B, and 1C according to a second aspect are the steam turbines 1A, 1B, and 1C of (1) that further include the vane end extending portion 49c that is continuously formed on the outer side Dro in the radial direction Dr with respect to the second-side concave portion 49b and that extends toward the second side Dad in the axial direction Da.

Accordingly, because of the effect of a centrifugal force caused by a swirling stream flowing out from the stator vanes 42, 42B, and 42C, liquid droplets flowing toward the outer side Dro in the radial direction Dr can be restrained from being accumulated at the second-side concave portion 49b. Therefore, the liquid droplets can be smoothly guided from the vane end extending portion 49c to the outer ring 43. Since the liquid droplets are guided to the outer ring 43 in such a manner, the amount of liquid droplets reaching the end portion 32a of the rotor blade 32 on the first side Dau in the axial direction Da can be suppressed more effectively.

(3) The steam turbines 1B and 1C according to a third aspect are the steam turbines 1B and 1C according to (1) or (2) in which the stator vanes 42B and 42C have a hollow structure with the cavity portion 47 formed therein, and the communication bole 50 through which an outer surface of the stator vanes 42B and 42C and the cavity portion 47 communicate with each other is formed closer to the outer side Dro in the radial direction Dr than the intermediate position 42m is.

Accordingly, at least a portion of liquid droplets can be recovered at the cavity portion 47 in the stator vanes 42B and 42C through the communication hole 50. Accordingly, the amount of liquid droplets reaching the end portion 32a of the rotor blade 32 that is on the first side Dau in the axial direction Da can be suppressed more effectively.

In addition, in the steam turbines 1B and 1C, the communication hole 50 is formed closer to the outer side Dro in the radial direction Dr than the intermediate position 42m is. Therefore, the processing area of the communication hole 50 can be reduced.

In addition, in the steam turbines 1B and 1C, the communication hole 50 is formed closer to the outer side Dro in the radial direction Dr than the intermediate position 42m is. Therefore, the cavity portion 47 of the stator vane 42B can be made small in relation to the position of the communication hole 50. Therefore, liquid droplets in the cavity portion 47 are easily discharged.

(4) The steam turbine 1C according to a fourth aspect is the steam turbine 1C of (3) in which, in the stator vane 42C, the partition wall 55 that partitions the cavity portion 47 into a part on the first side Dau in the axial direction Da and a part on the second side Dad in the axial direction Pa is formed closer to the first side Dai in the axial direction Da than the communication hole 50 is.

Accordingly, it is possible to reduce a flow path cross-sectional area at a portion (which is the second cavity portion 47d) that is on the second side Dad in the axial direction Da with respect to the partition wall 55 of the cavity portion 47 in the stator vane 42C and at which liquid droplets are recovered. In addition, it is possible to restrain liquid droplets recovered into the cavity portion 47 in the stator vane 42C from moving to the first cavity portion 47u in the stator vane 42C, the first cavity portion 47u being closer to the first side Dau in the axial direction Da than the partition wall 55 is. Therefore, it is possible to configure a portion of the stator vane 42C that is close to the first-side edge portion 48 on the first side Dau in the axial direction Da to have a sealed heat blocking structure.

(5) The steam turbines 1A, 1B, and 1C according to a fifth aspect are the steam turbines 1A, 1B, and 1C according to any one of (1) to (4) in which the first-side edge portion 48 of the stator vanes 42, 42B, and 42C that is on the first side Dau in the axial direction Da includes the first-side concave portion 48a that is formed at a portion of the stator vanes 42, 42B, and 42C on the inner side Dri in the radial direction Dr and that is recessed while being curved toward the second side Dad in the axial direction Da, and the first-side convex portion 48b that is formed on the outer side Dro in the radial direction Dr with respect to the first-side concave portion 48a and that protrudes while being curved toward the first side Dau in the axial direction Da.

Accordingly, a difference between a flow path length from the first-side concave portion 48a to the second-side convex port ion 49a in the axial direction Da and a flow path length from the first-side convex portion 48b to the second-side concave portion 49b in the axial direction Da can be restrained from being large in comparison with a case where the first-side edge portion 48 of the stator vanes 42, 42B, and 42C is formed in a linear shape extending along the radial direction Dr. Accordingly, a friction loss generated between the liquid droplets and a surface of the stator vanes 42, 42B, and 42C can be restrained from being significantly different in the radial direction Dr.

### INDUSTRIAL APPLICABILITY

According to the steam turbine described above, it is possible to effectively suppress the occurrence of erosion while suppressing a decrease in turbine performance and a decrease in shaft vibration reliability.

### REFERENCE SIGNS LIST

1A, 1B, 1C: steam turbine
10: casing
20: rotor
21: rotor shaft
22: shaft core portion
23: disc portion
31: rotor blade row
31F: last rotor blade row
32: rotor blade
32a: end portion
34: shroud
35: platform
41: stator vane row
41F: last stator vane row
42, 42B, 42C: stator vane
42a: pressure surface
42b: suction surface
42m: intermediate position
42s: inner end
42t: outer end
43: outer ring
44: inner ring
45: pressure-side member
46: suction-side member
47: cavity portion
47d: second cavity portion
47u: first cavity portion
48: first-side edge portion
48a: first-side concave portion
48b: first-side convex portion
49: second-side edge portion
49a: second-side convex portion
49b: second-side concave portion
49c: vane end extending portion
50: communication hole
55: partition wall
Da: axial direction
Dad: second side
Dau: first side
Dc: circumferential direction
Dr: radial direction
Dri: inner side
Dro: outer side
L1: virtual line
O: axis
S: steam

1. A steam turbine comprising:
a rotor shaft that rotates around an axis;
a plurality of rotor blade rows that are disposed at intervals in an axial direction along the axis, the rotor blade rows being fixed to a portion of the rotor shaft that is on an outer side in a radial direction;
a casing that is disposed to cover the rotor shaft and the plurality of rotor blade rows; and
stator vane rows that are disposed at intervals in the axial direction and that are disposed on a first side in the axial direction with respect to the plurality of rotor blade rows, respectively, the stator vane rows being fixed to a portion of the casing that is on an inner side in the radial direction,
wherein each stator vane row includes
a plurality of stator vanes that are disposed at intervals in a circumferential direction and each of which extends in the radial direction,
an outer ring that has an annular shape and that is disposed closer to the outer side in the radial direction than the plurality of stator vanes are, and
an inner ring that has an annular shape and that is disposed closer to an inner side in the radial direction than the plurality of stator vanes are, and
wherein at a last stator vane row that is disposed to be closest to a second side in the axial direction among the plurality of stator vane rows, a second-side edge portion of the stator vane that is on the second side in the axial direction has an S-like shape including a second-side convex portion that is formed on the inner side in the radial direction with respect to an intermediate position between an outer end of the stator vane on the outer side in the radial direction and an inner end of the stator vane on the inner side in the radial direction and that protrudes while being curved toward the second side in the axial direction, and a second-side concave portion that is formed on the outer side in the radial direction with respect to the intermediate position and that is recessed while being curved toward the first side in the axial direction,
wherein the stator vane has a hollow structure with a cavity portion formed therein,
wherein a communication hole through which an outer surface of a pressure-side member of the stator vane and the cavity portion communicate with each other is formed closer to the outer side in the radial direction than the intermediate position is, and
wherein a partition wall that partitions the cavity portion into a part on the first side in the axial direction and a part on the second side in the axial direction is formed closer to the first side in the axial direction than the communication hole is.

2. The steam turbine according to claim 1, further comprising:
a vane end extending portion that is continuously formed on the outer side in the radial direction with respect to the second-side concave portion and that extends toward the second side in the axial direction.

3. (canceled)

4. (canceled)

5. The steam turbine according to claim 1,
wherein a first-side edge portion of the stator vane that is on the first side in the axial direction includes
a first-side concave portion that is formed at a portion of the stator vane on the inner side in the radial direction and that is recessed while being curved toward the second side in the axial direction, and
a first-side convex portion that is formed on the outer side in the radial direction with respect to the first-side concave portion and that protrudes while being curved toward the first side in the axial direction.

6. The steam turbine according to claim 1,
the communication hole is formed only at a position closer to the second-side edge portion than a first-side edge portion of the stator vane that is on the second side in the axial direction is.

7. The steam turbine according to claim 1,
the stator vane is an assembly having a split structure composed of a component including the communication hole and a component including no communication hole with the partition wall serving as a boundary.
